(19) United States
(12) Patent Application Publication
(10) Pub. No.: US 2020/0294007 A1
(43) Pub. Date: Sep. 17, 2020

(54) INFORMATION RELAY DEVICE, INFORMATION RELAY METHOD, AND PROGRAM

(71) Applicant: MITSUBISHI HEAVY INDUSTRIES MACHINERY SYSTEMS, LTD., Kobe-shi, Hyogo (JP)

(72) Inventors: Yoshifumi HAYAKAWA, Tokyo (JP); Yamato ITO, Tokyo (JP)

(21) Appl. No.: 16/759,399

(22) PCT Filed: Oct. 31, 2017
(86) PCT No.: PCT/JP2017/039438

§ 371 Date: Apr. 27, 2020

(51) Int. Cl. G06Q 20/08; G06Q 50/30; G06Q 20/02; G06Q 20/40; G06Q 20/10; H04L 29/06

(52) U.S. Cl. CPC G06Q 20/0855; G06Q 50/30; G06Q 20/027; G06Q 20/4014; G06Q 2220/00; G06Q 20/108; H04L 63/0428; G06Q 2240/00; G06Q 20/4037

(57) ABSTRACT

An information relay device (30) includes a reception unit (300) configured to receive information including identification information for identifying a user of the toll road and a usage fee of the toll road for the user, a storage medium (310) storing a registration table in which the identification information and account information for identifying a payment means of the user are pre-registered in association, a security communication unit (302) provided from the service provider and configured to generate encrypted information in which the account information associated with the identification information and the usage fee are encrypted, and a transmission unit (303) configured to transmit the encrypted information to the service provider.

### TECHNICAL FIELD

The present invention relates to an information relay device, an information relay method, and a program.

### BACKGROUND ART

As a system for collecting a usage fee of a toll road, an electronic toll collection system (ETC) (registered trademark) (also referred to as an “automated toll collection system”) in which a toll collection process is performed by performing wireless communication between an on-board unit mounted on a vehicle and a roadside device installed in a toll booth on the toll road has become widespread.

In the electronic toll collection system, the roadside device installed in the toll booth acquires various types of information necessary for the toll collection process such as card information (a card number, an expiration date, and the like) recorded in an IC card (such as an “ETC card”) issued to the user in advance, passage history information (a number of the toll booth through which a user has passed, a passage time, and the like) and performs a process of collecting a usage fee for a vehicle on the basis of the card information and the usage fee according to the passage history information. At this time, in the electronic toll collection system, a card issuer (a credit card company or the like) issuing an IC card pays a usage fee to a business operator of a toll road on behalf of the user and the usage fee is collected according to deferred payment in which the usage fee is later deducted from a bank account associated with the card by the card issuer (for example, see Non-Patent Document 1).

### CITATION LIST

### Non-Patent Literature

### Non-Patent Document 1

“2016 Edition ETC Handbook,” [online], General Foundation Corporation, ITS Technology Enhancement Association, p. 24, Internet <URL:https://www.its-tea.or.jp/library/pdf/h28_ETC_binran_web.pdf>

### SUMMARY OF INVENTION

### Technical Problem

In recent years, a financial service mechanism called FinTech that uses technologies such as information and communication technology (ICT) and blockchain has attracted attention. As an aspect of the service of FinTech, for example, a payment service in which various types of payment means such as electronic money, vouchers, points, virtual currency, a debit card (a payment card associated with a deposit account), and a credit card are available is considered.

As described above, in the conventional electronic toll collection system, the user cannot pay the usage fee using a payment means other than a payment means designated by the card issuer (deferred payment such as credit card payment). Thus, there has been a demand for the introduction of a payment service in which various types of payment means are available in a toll collection system for a toll road.

### Solution to Problem

In order to solve the above-described problems, the present invention adopts the following means.

According to a first aspect of the present invention, there is provided an information relay device (30) for relaying information related to a payment process from and to a service provider for performing the payment process of paying a usage fee of a toll road, the information relay device (30) including: a reception unit (300) configured to receive information including identification information for identifying a user of the toll road and the usage fee of the toll road for the user; a storage medium (310) storing a registration table in which the identification information and account information for identifying a payment means of the user are pre-registered in association; a security communication unit (302) provided from the service provider and configured to generate encrypted information in which the account information associated with the identification information and the usage fee are encrypted; and a transmission unit (303) configured to transmit the encrypted information to the service provider.

Thereby, the information relay device can request payment according to the account information by transmitting the encrypted information including the account information and the usage fee to the service provider even if a different payment means is designated for each user. Thereby, the information relay device can be compatible with a payment service using various types of payment means as well as a credit card.

According to a second aspect of the present invention, the information relay device (30) according to the first aspect further includes a notification unit (305) configured to notify that a balance is insufficient when the balance in the payment means is less than the usage fee.

Thereby, the information relay device can immediately notify the user that the balance in the payment means is insufficient.

According to a third aspect of the present invention, there is provided an information relay device (30) provided in a service provider for performing a payment process of paying a usage fee of a toll road, the information relay device (30) including: a reception unit (300) configured to receive information including identification information for identifying a user of the toll road and the usage fee of the toll road for the user; a storage medium (310) storing a registration table in which the identification information and account information for identifying a payment means of the user are pre-registered in association; and a payment request unit (306) configured to identify a payer for providing the payment means on the basis of the account information associated with the identification information and transmit payment request information including the account information and the usage fee to the payer.

Thereby, the information relay device can appropriately transmit a payment request to each of the payers providing the payment means on the basis of the account information even if a different payment means is designated for each user. Thereby, the information relay device can provide the user with a payment service using various types of payment means as well as a credit card.

According to a fourth aspect of the present invention, the information relay device (30) according to the third aspect further includes a notification unit (305) configured to notify that a balance is insufficient when the balance in the payment means is less than the usage fee.

Thereby, the information relay device can immediately notify the user that the balance in the payment means is insufficient.

According to a fifth aspect of the present invention, there is provided an information relay method of relaying information related to a payment process from and to a service provider for performing the payment process of paying a usage fee of a toll road, the information relay method including the steps of: receiving information including identification information for identifying a user of the toll road and the usage fee of the toll road for the user; generating encrypted information in which account information associated with the identification information and the usage fee are encrypted by a security communication unit provided from the service provider; and transmitting the encrypted information to the service provider.

According to a sixth aspect of the present invention, there is provided an information relay method of relaying information related to a payment process of paying a usage fee of a toll road, the information relay method including the steps of: receiving information including identification information for identifying a user of the toll road and the usage fee of the toll road for the user; and identifying a payer for providing a payment means on the basis of account information associated with the identification information and transmitting payment request information including the account information and the usage fee to the payer.

According to a seventh aspect of the present invention, there is provided a program for causing a computer of an information relay device (30) for relaying information related to a payment process from and to a service provider for performing the payment process of paying a usage fee of a toll road to function and execute the steps of: receiving information including identification information for identifying a user of the toll road and the usage fee of the toll road for the user; generating encrypted information in which account information associated with the identification information and the usage fee are encrypted by a security communication unit provided from the service provider; and transmitting the encrypted information to the service provider.

According to an eighth aspect of the present invention, there is provided a program for causing a computer of an information relay device (30) provided in a service provider for relaying information related to a payment process of paying a usage fee of a toll road to function and execute the steps of: receiving information including identification information for identifying a user of the toll road and the usage fee of the toll road for the user; and identifying a payer for providing a payment means on the basis of account information associated with the identification information and transmitting payment request information including the account information and the usage fee to the payer.

### Advantageous Effects of Invention

According to the information relay device, the information relay method, and the program described above, it is possible to provide a payment service in which a plurality of types of payment means are available.

### BRIEF DESCRIPTION OF DRAWINGS

FIG. 1 is a diagram schematically showing a toll collection system according to a first embodiment of the present invention.

FIG. 2 is a diagram showing a functional configuration of the toll collection system according to the first embodiment of the present invention.

FIG. 3 is a diagram showing an example of fee information according to the first embodiment of the present invention.

FIG. 4 is a diagram showing an example of a registration table according to the first embodiment of the present invention.

FIG. 5 is a diagram showing an example of bill information according to the first embodiment of the present invention.

FIG. 6 is a diagram showing an example of payment information according to the first embodiment of the present invention.

FIG. 7 is a diagram showing an example of payment request information according to the first embodiment of the present invention.

FIG. 8 is a flowchart showing an example of a process of an information relay device according to the first embodiment of the present invention.

FIG. 9 is a flowchart showing an example of a process of a processing device according to the first embodiment of the present invention.

FIG. 10 is a diagram showing a functional configuration of a toll collection system according to a second embodiment of the present invention.

FIG. 11 is a diagram schematically showing a toll collection system according to a third embodiment of the present invention.

FIG. 12 is a diagram showing a functional configuration of the toll collection system according to the third embodiment of the present invention.

FIG. 13 is a flowchart showing an example of a process of an information relay device according to the third embodiment of the present invention.

FIG. 14 is a schematic block diagram showing a configuration of a computer according to at least one embodiment of the present invention.

### DESCRIPTION OF EMBODIMENTS

### First Embodiment

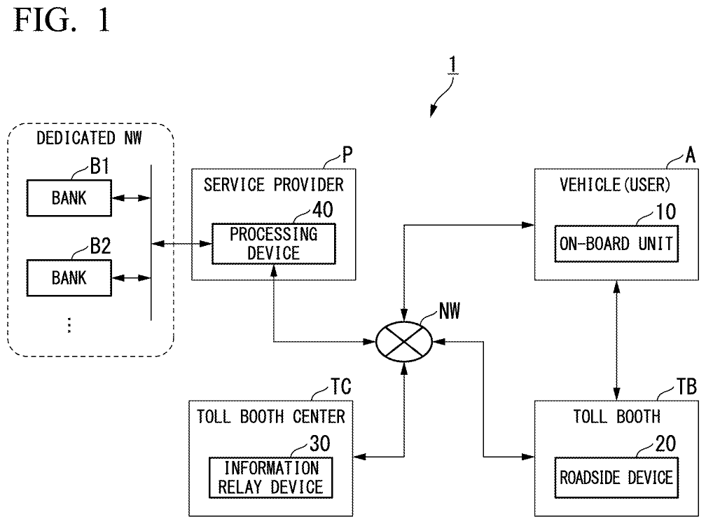

Hereinafter, a toll collection system 1 according to a first embodiment of the present invention will be described with reference to FIGS. 1 to 9.

### (Overall Configuration of Toll Collection System)

FIG. 1 is a diagram schematically showing the toll collection system according to the first embodiment of the present invention.

As shown in FIG. 1, the toll collection system 1 includes a vehicle A that travels on a toll road, a toll booth TB on the toll road, a toll booth center TC, and a service provider P for providing a payment service for a usage fee of the toll road.

The toll booth TB is, for example, an exit toll booth provided at an exit of the toll road and includes various types of facilities for collecting a usage fee of the toll road from the vehicle A that travels on the toll road. Also, in another embodiment, the toll booth TB may be an entrance toll booth provided at an entrance of the toll road.

For example, the toll booth TB includes a roadside device 20 as the facility for collecting the usage fee from the vehicle A.

The roadside device 20 performs wireless communication with an on-board unit 10 mounted on the vehicle A and therefore performs a process of collecting the usage fee for the vehicle A entering a communication area (also referred to as a “toll collection process”).

The toll booth center TC has an information relay device 30 configured to collect information related to the usage fee for the vehicle A via a network (NW) such as the Internet and transmit the information to the service provider P to be described below.

The service provider P is a company that performs a payment process (a payment service) in which a usage fee of the toll road is paid using the FinTech mechanism without the use of cash.

The service provider P has a processing device 40 configured to perform a payment process of paying the usage fee on the basis of information received from the information relay device 30 of the toll booth center TC. The processing device 40 identifies a payer that provides a payment means on the basis of the information received from the information relay device 30 and requests the payer to pay the usage fee. The payment means is, for example, payment (remittance) using an account (hereinafter, referred to as a “bank account”) of a financial institution that handles savings and deposits such as a bank, a credit card, or a social networking service (SNS). The account information is information such as a “bank account ID and a PIN,” a “credit card number and an expiration date,” and an “SNS account ID and a PIN” for identifying these payment means. The payer is a company that performs payment of the usage fee on behalf of the user from the user's payment means, and is, for example, a bank, a credit card company, an SNS operating company, or the like. In the present embodiment, as shown in FIG. 1, an aspect in which the payer is a bank (a bank B1, a bank B2, or the like) will be described as an example. In response to a request from the service provider P, the bank that is the payer pays the usage fee from the user's payment means (for example, a bank account in the bank B1). Also, the payer and the service provider P (the processing device 40) are connected so that they can perform communication via a dedicated network (NW) to which high security is applied.

Also, although an example in which the toll collection system 1 has only one service provider P is shown in FIG. 1, the present invention is not limited thereto. In another embodiment, the toll collection system 1 may have a plurality of service providers P. Also, although an aspect in which the service provider P is a company different from the payer will be described as an example in the present embodiment, the present invention is not limited thereto. In another embodiment, the service provider P and the payer may be the same company.

### (Functional Configuration of Toll Collection System)

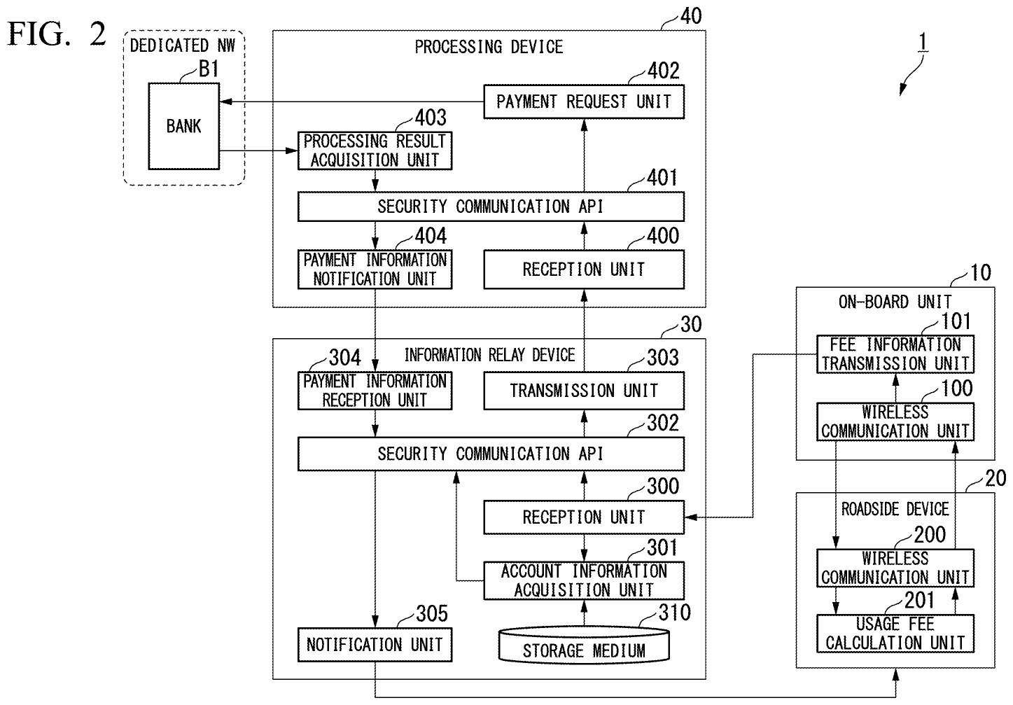

FIG. 2 is a diagram showing a functional configuration of the toll collection system according to the first embodiment of the present invention.

As shown in FIG. 2, the on-board unit 10 according to the present embodiment includes a wireless communication unit 100 and a fee information transmission unit 101.

The wireless communication unit 100 transmits and receives various types of information related to the toll collection process by performing wireless communication based on, for example, dedicated short-range communication (DSRC) technology, with the roadside device 20. Specifically, the wireless communication unit 100 transmits identification information of the vehicle A, a vehicle type classification, and information for identifying a travel distance of the toll road (for example, entrance information including a number of an entrance toll booth through which the vehicle A has entered the toll road and an entry time when the vehicle A has entered the toll road) to the roadside device 20 and receives information related to the usage fee of the user (a driver of the vehicle A or the like) from the roadside device 20. Also, the wireless communication unit 100 may transmit a type of discount applied to the user (for example, a discount for the disabled or the like) and a discount classification for identifying an amount of discount to the roadside device 20.

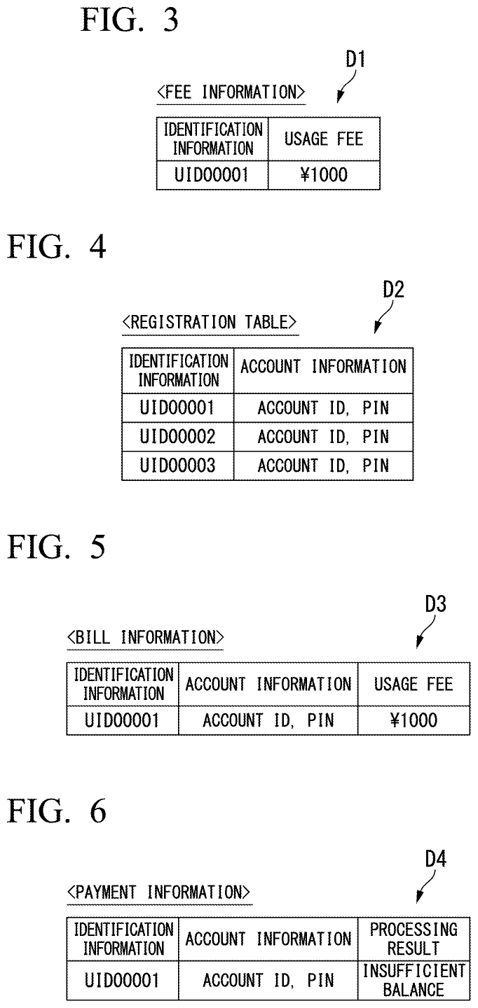

The fee information transmission unit 101 transmits “fee information D1 (FIG. 3)” to the information relay device 30 via a network (NW) such as the Internet.

FIG. 3 is a diagram showing an example of fee information according to the first embodiment of the present invention.

As shown in FIG. 3, the fee information D1 includes “identification information” for identifying a user of the toll road and a “usage fee” of the toll road for the user. The identification information is a unique ID such as an on-board unit ID or a user ID.

Also, as shown in FIG. 2, the roadside device 20 according to the present embodiment includes a wireless communication unit 200 and a usage fee calculation unit 201.

The wireless communication unit 200 transmits and receives various types of information related to the toll collection process by performing wireless communication with the on-board unit 10.

The usage fee calculation unit 201 calculates the usage fee for the user on the basis of various types of information (a vehicle type classification, a discount classification, and a travel distance) related to the toll collection process received by the wireless communication unit 200. Also, the usage fee calculated by the usage fee calculation unit 201 is transmitted from the wireless communication unit 200 to the on-board unit 10.

Also, as shown in FIG. 2, the information relay device 30 according to the present embodiment includes a reception unit 300, an account information acquisition unit 301, a security communication application programming interface (API) 302 (a security communication unit), a transmission unit 303, a payment information reception unit 304, a notification unit 305, and a storage medium 310.

The reception unit 300 receives the “fee information D1 (FIG. 3)” from the on-board unit 10 via a network such as the Internet.

The account information acquisition unit 301 acquires “account information” associated with “identification information” of the user from the storage medium 310.

FIG. 4 is a diagram showing an example of a registration table according to the first embodiment of the present invention.

As shown in FIG. 4, in the storage medium 310, a “registration table D2” in which “identification information” for identifying the user and “account information” for identifying a payment means of the user are pre-registered in association is stored.

The account information acquisition unit 301 retrieves and acquires the account information from the registration table D2 using the identification information received by the reception unit 300 as a key.

The security communication API 302 is an API provided from the service provider P and is a functional unit having a connection function related to a connection to the processing device 40 provided in the service provider P and a security function of encrypting and decrypting information transmitted and received between the information relay device 30 and the processing device 40.

FIG. 5 is a diagram showing an example of bill information according to the first embodiment of the present invention.

As shown in FIG. 5, the security communication API 302 according to the present embodiment generates encrypted information (“bill information D3”) by encrypting the “usage fee” included in the fee information D1 received by the reception unit 300 and the “account information” acquired by the account information acquisition unit 301 from the registration table D2 using the encryption key information of the service provider P incorporated in the API in advance. Also, the bill information D3 may further include “identification information.”

Also, the security communication API 302 performs a process of establishing a connection for transmitting and receiving information to and from the processing device 40 on the basis of connection information (information indicating a connection destination and a connection method) for connecting to the processing device 40 incorporated in the API in advance.

When the security communication API 302 establishes a connection with the processing device 40, the transmission unit 303 transmits the “bill information D3” generated by the security communication API 302 to the processing device 40.

The payment information reception unit 304 receives “payment information D4 (FIG. 6)” indicating whether or not the payment from the user's payment means (bank account) has succeeded from the processing device 40.

FIG. 6 is a diagram showing an example of payment information according to the first embodiment of the present invention.

As shown in FIG. 6, the payment information D4 includes the “account information” of the user and a “processing result” indicating whether or not the payment of the usage fee has succeeded.

When the processing result indicates that the payer has paid the usage fee normally, information indicating “payment completion” is input. When the balance in the bank account is less than the usage fee and payment has not been made, information indicating an “insufficient balance” is input.

Also, the payment information D4 may include the “identification information” of the user so that the user can be easily identified.

When the payment information D4 received by the payment information reception unit 304 includes information indicating that the balance in the payment means of the user is insufficient, the notification unit 305 notifies the roadside device 20 of the information. When the payer is a bank, the balance is the balance in the bank account. The balance is, for example, an available balance, when the payer is a credit card company and the balance is, for example, a charge balance in an SNS account, when the payer is an SNS operating company.

Also, as shown in FIG. 2, the processing device 40 according to the present embodiment includes a reception unit 400, a security communication API 401 (a security communication unit), a payment request unit 402, a processing result acquisition unit 403, and a payment information notification unit 404.

The reception unit 400 receives the “bill information D3 (FIG. 5)” including the account information and the usage fee from the information relay device 30.

The security communication API 401 is a functional unit having a security function of encrypting and decrypting information transmitted and received between the information relay device 30 and the processing device 40.

The security communication API 401 decrypts the “bill information D3” using the encryption key information of the service provider P incorporated in the API in advance.

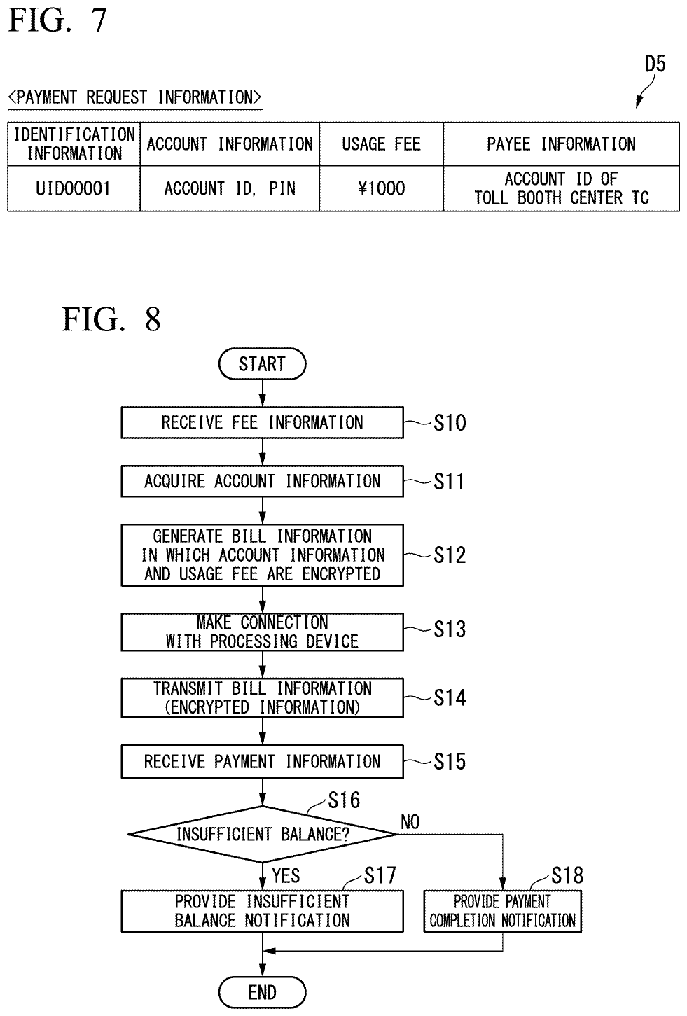

The payment request unit 402 transmits “payment request information D5 (FIG. 7)” including the “account information” and the “usage fee” to the payer (the bank B1) providing the payment means identified from the “account information” included in the bill information D3 that has been decrypted. Thereby, the payment request unit 402 requests the payer to pay the usage fee.

FIG. 7 is a diagram showing an example of the payment request information according to the first embodiment of the present invention.

As shown in FIG. 7, the payment request information DS includes the “account information” for identifying the payment means of the user, the “usage fee,” and “payee information” indicating a payee of the usage fee. Also, the payment request information D5 may include information for enabling the user to be easily identified such as “identification information.”

When the payer (the bank B1) receives the payment request from the information relay device 30, the payer (the bank B1) executes a process of paying (transmitting) the “usage fee” from the bank account of the user identified from the “account information” to the account of the payee (for example, the bank account of the toll booth center TC) with reference to the payment request information D5.

The processing result acquisition unit 403 acquires the processing result related to the payment of the usage fee by the payer. The processing result acquisition unit 403 acquires a processing result indicating “payment completion” when the payer has paid the usage fee from the user's bank account normally. Also, the processing result acquisition unit 403 acquires a processing result indicating an “insufficient balance” when the payment of the usage fee has failed because the balance in the bank account of the user is insufficient.

The payment information notification unit 404 generates “payment information D4 (FIG. 6)” including the “processing result” acquired by the processing result acquisition unit 403 and transmits the generated information to the information relay device 30.

### (Process Flow of Information Relay Device)

FIG. 8 is a flowchart showing an example of a process of the information relay device according to the first embodiment of the present invention.

Hereinafter, an example of a process in which the information relay device 30 relays various types of information related to the toll collection process will be described with reference to FIG. 8.

When the vehicle A reaches the toll booth TB, wireless communication is performed between the on-board unit 10 mounted on the vehicle A and the roadside device 20 and the usage fee according to the travel distance of the vehicle A, the vehicle type classification, and the like is calculated. At this time, the on-board unit 10 transmits the “fee information D1 (FIG. 3)” including the “identification information” of the user and the calculated “usage fee” to the information relay device 30 via a network such as the Internet.

Then, as shown in FIG. 8, the reception unit 300 receives the “fee information D1” from the on-board unit 10 (step S10).

Next, the account information acquisition unit 301 retrieves and acquires “account information” associated with the “identification information” of the user from the registration table D2 (FIG. 4) pre-stored in the storage medium 310 (FIG. 4) (step S11).

Next, the security communication API 302 generates encrypted information (the “bill information D3 (FIG. 5)”) in which the “usage fee” received by the reception unit 300 in step S10 and the “account information” acquired by the account information acquisition unit 301 in step S11 are encrypted using the encryption key information of the service provider P incorporated in the API in advance (step S12).

Next, the security communication API 302 performs a process of establishing a connection for transmitting and receiving information to and from the processing device 40 on the basis of connection information (information indicating a connection destination and a connection method) for connecting to the processing device 40 incorporated in the API in advance (step S13).

Next, when the security communication API 302 establishes a connection with the processing device 40, the transmission unit 303 transmits the “bill information D3” (the encrypted information) generated by the security communication API 302 to the processing device 40 (step S14).

Then, the processing device 40 performs the payment process of paying the usage fee on the basis of the bill information D3.

Next, the payment information reception unit 304 receives the “payment information D4 (FIG. 6)” indicating whether or not the payment from the user's payment means (bank account) has succeeded from the processing device 40 (step S15).

The payment information reception unit 304 can ascertain whether the usage fee for the user has been paid normally, or whether the balance is insufficient, with reference to the “processing result” of the payment information D4.

Next, the notification unit 305 determines whether or not the balance in the user's payment means (the bank account of the bank B1) is insufficient (step S16).

When the “processing result” included in the payment information D4 is an “insufficient balance” (step S16: YES), the notification unit 305 notifies the roadside device 20 that the balance in the user's payment means (bank account) is insufficient with respect to the usage fee (step S17). Then, the roadside device 20 provides a notification (an output) indicating that the balance is insufficient to the user via an output device (a display device, a speaker, or the like) (not shown).

On the other hand, when the “processing result” included in the payment information D4 is “payment completion” (step S16: NO), the notification unit 305 notifies the roadside device 20 that the payment of the usage fee from the payment means (the bank account) has been completed normally (step S18).

Also, the payment information D4 received by the payment information reception unit 304 is encrypted and the notification unit 305 can refer to various types of information included in the payment information D4 by decrypting the payment information D4 using the security communication API 302.

### (Process Flow of Processing Device)

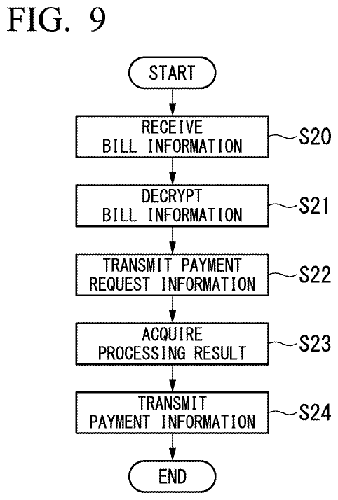

FIG. 9 is a flowchart showing an example of a process of the processing device according to the first embodiment of the present invention.

Hereinafter, an example of the payment process in the processing device 40 will be described with reference to FIG. 9.

As shown in FIG. 9, first, the reception unit 400 receives the “bill information D3 (FIG. 5)” from the information relay device 30 (step S20).

Next, the security communication API 401 decrypts the “bill information D3” using encryption key information of the service provider P incorporated in the API in advance (step S21).

Next, the payment request unit 402 extracts “account information” and a “usage fee” from the bill information D3 that has been decrypted. Then, the payment request unit 402 transmits the payment request information “D5 (FIG. 7)” to the payer (bank B1) providing a payment means (a bank account in the bank B1) identified from the “account information” via the dedicated network (step S22).

Specifically, as shown in FIG. 7, the payment request unit 402 generates the payment request information D5 including “identification information” and the “account information” of the user, the “usage fee,” and “payee information.” At this time, the payment request unit 402 includes information (for example, an account ID of the toll booth center TC) indicating a bank account or the like pre-designated by the toll booth center TC which is a transmission source of the bill information D3 as the “payee information” in the payment request information D5.

When such payment request information D5 is received, the payer executes a process of paying (transmitting) the “usage fee” from the user's bank account identified from the “account information” to the bank account of the toll booth center TC identified by the “payee information.”

Next, the processing result acquisition unit 403 acquires the processing result related to the payment of the usage fee by the payer (step S23).

The processing result acquisition unit 403 acquires a processing result indicating “payment completion” when the payer has paid the usage fee from the user's bank account normally. Also, the processing result acquisition unit 403 acquires a processing result indicating an “insufficient balance” when the payment of the usage fee has failed because the balance in the user's bank account is insufficient.

Next, the payment information notification unit 404 generates “payment information D4 (FIG. 6)” including the “processing result” acquired by the processing result acquisition unit 403 and transmits the payment information D4 to the information relay device 30 (step S24).

At this time, the payment information notification unit 404 encrypts the payment information D4 using the security communication API 401 and transmits the encrypted information to the information relay device 30.

The processing device 40 executes the above-described process every time the bill information D3 is received from the information relay device 30.

### (Operation and Effect)

As described above, according to the present embodiment, the information relay device 30 for relaying information related to a payment process from and to the service provider P for performing the payment process of paying a usage fee of a toll road includes the reception unit 300 configured to receive the fee information D1 including identification information for identifying a user of the toll road and the usage fee of the toll road for the user; the storage medium 310 storing the registration table D2 in which the identification information and account information for identifying a payment means of the user are pre-registered in association; the security communication API 302 (a security communication unit) provided from the service provider P and configured to generate encrypted information (the bill information D3) in which the account information associated with the identification information and the usage fee are encrypted; and the transmission unit 303 configured to transmit the encrypted information to the service provider P.

Thereby, the information relay device 30 can request payment according to the account information by transmitting the encrypted information including the account information and the usage fee to the service provider P even if a different payment means is designated for each user. Thereby, the information relay device can be compatible with a payment service using various types of payment means as well as a credit card.

Also, the information relay device 30 further includes the notification unit 305 configured to notify that a balance is insufficient when the balance in the payment means is less than the usage fee.

Thereby, the information relay device 30 can immediately notify the user that the balance in the payment means (for example, a bank account) is insufficient.

In the present embodiment, the payer may be a bank and the payment means may be a bank account.

Because high-level security is required for a dedicated network for accessing a bank account, a conventional system does not have a mechanism for performing payment by making a direct connection from the toll booth center TC on the toll road to the bank account.

However, in the toll collection system 1 according to the present embodiment, the information relay device 30 of the toll booth center TC and the processing device 40 of the service provider P relay information to and from the bank and therefore a payment request for the usage fee of the toll road can be issued to the bank that is the payer without lowering the security level of the dedicated network for accessing the bank account. Thereby, the toll collection system 1 can provide the user of the toll road with a payment service for immediately paying a usage fee from the bank account of the user.

Also, the security communication API 302 is an API provided from the service provider P and performs a process of establishing a connection for transmitting and receiving information to and from the processing device 40 on the basis of connection information (information indicating a connection destination and a connection method) for connecting to the processing device 40 incorporated in the API in advance. Also, the security communication API 302 generates encrypted information (the “bill information D3”) by performing encryption using the encryption key information of the service provider P incorporated in the API in advance.

Thereby, the connection information and the encryption key information can be incorporated in the information relay device 30 in a state in which the connection information and the encryption key information are confidentially kept within the API without being disclosed to the public. Thereby, the information relay device 30 can be connected to the processing device 40 provided in the service provider P in a state in which the security level required by the payer (the bank) is maintained. Also, the information relay device 30 can transmit and receive account information and the like for identifying a bank account in a state in which high confidentiality is maintained.

### Second Embodiment

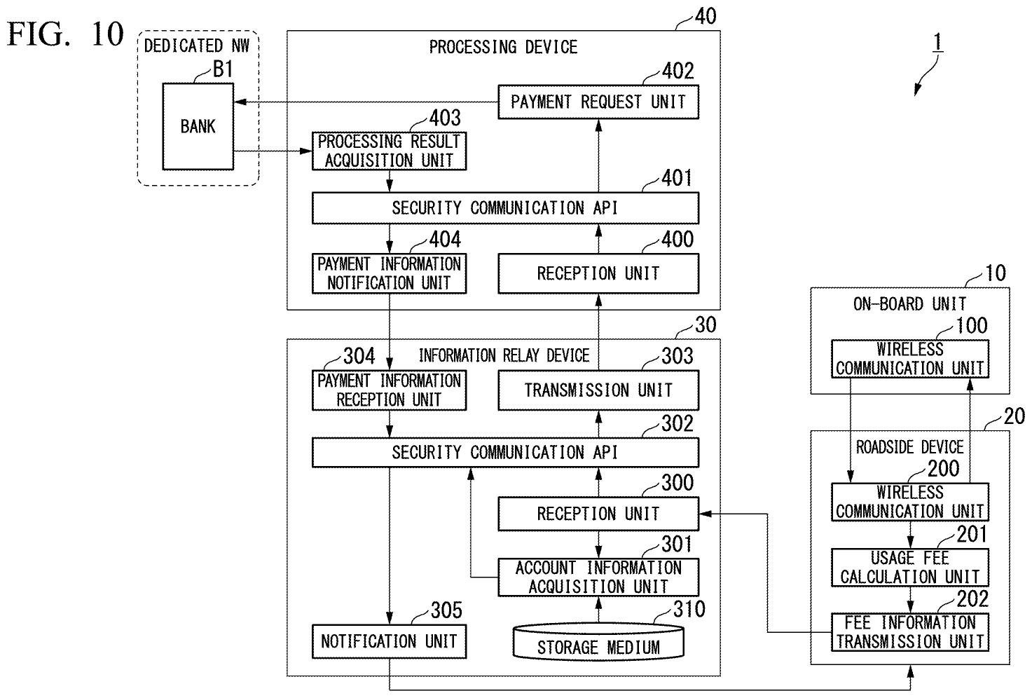

FIG. 10 is a diagram showing a functional configuration of a toll collection system according to a second embodiment of the present invention.

Hereinafter, a toll collection system 1 according to the second embodiment of the present invention will be described with reference to FIG. 10. Components common to the first embodiment are denoted by the same reference signs and a detailed description thereof will be omitted.

The present embodiment is different from the first embodiment in that a roadside device 20 transmits “fee information D1” to an information relay device 30 instead of an on-board unit 10.

As shown in FIG. 3, the on-board unit 10 according to the present embodiment has a wireless communication unit 100.

The wireless communication unit 100 transmits and receives various types of information related to a toll collection process by performing wireless communication with the roadside device 20 as in the first embodiment.

The wireless communication unit 100 according to the present embodiment may perform wireless communication based on DSRC technology or may perform wireless communication based on radio frequency identification (RFID) technology.

Also, as shown in FIG. 3, the roadside device 20 according to the present embodiment includes a wireless communication unit 200, a usage fee calculation unit 201, and a fee information transmission unit 202.

The wireless communication unit 200 transmits and receives various types of information related to the toll collection process by performing wireless communication with the on-board unit 10 as in the first embodiment.

As in the first embodiment, the usage fee calculation unit 201 calculates the usage fee for the user on the basis of various types of information (a vehicle type classification, a discount classification, and a travel distance) related to the toll collection process received by the wireless communication unit 200. Also, the usage fee calculated by the usage fee calculation unit 201 may be transmitted from the wireless communication unit 200 to the on-board unit 10.

The fee information transmission unit 202 transmits “fee information D1 (FIG. 3)” including “identification information” received by the wireless communication unit 200 and a “usage fee” calculated by the usage fee calculation unit 201 to the information relay device 30 via a network (NW) such as the Internet.

Also, as shown in FIG. 3, the information relay device 30 according to the present embodiment includes a reception unit 300, an account information acquisition unit 301, a security communication application programming interface (API) 302 (a security communication unit), a transmission unit 303, a payment information reception unit 304, a notification unit 305, and a storage medium 310.

The reception unit 300 receives the “fee information D1 (FIG. 3)” from the roadside device 20 via a network such as the Internet.

Also, because functional components of the account information acquisition unit 301, the security communication API 302, the transmission unit 303, the payment information reception unit 304, the notification unit 305, and the storage medium 310 are similar to those of the first embodiment, a description thereof will be omitted.

Also, as shown in FIG. 10, the processing device 40 according to the present embodiment includes a reception unit 400, a security communication API 401 (a security communication unit), a payment request unit 402, a processing result acquisition unit 403, and a payment information notification unit 404.

Because these functional components are similar to those of the first embodiment, a description thereof will be omitted.

The toll collection system 1 according to the present embodiment has the above-described configuration, so that effects similar to those of the first embodiment can be obtained.

Further, in the toll collection system 1 according to the present embodiment, information to be transmitted and received between the on-board unit 10 and the roadside device 20 (“identification information” such as the on-board unit ID, a “vehicle type classification,” “entrance information,” a “usage fee,” and the like) is similar to information to be transmitted and received in the conventional toll collection system. Also, information to be transmitted and received between the roadside device 20 and the information relay device 30 (the “fee information D1” including the “identification information” and the “usage fee”) is similar to information to be transmitted and received in the conventional toll collection system. Therefore, because the toll collection system 1 according to the present embodiment can use the on-board unit 10 and the roadside device 20 used in the conventional toll collection system, it is possible to reduce the cost for newly developing and replacing a plurality of on-board units 10 and a plurality of roadside devices 20.

### Third Embodiment

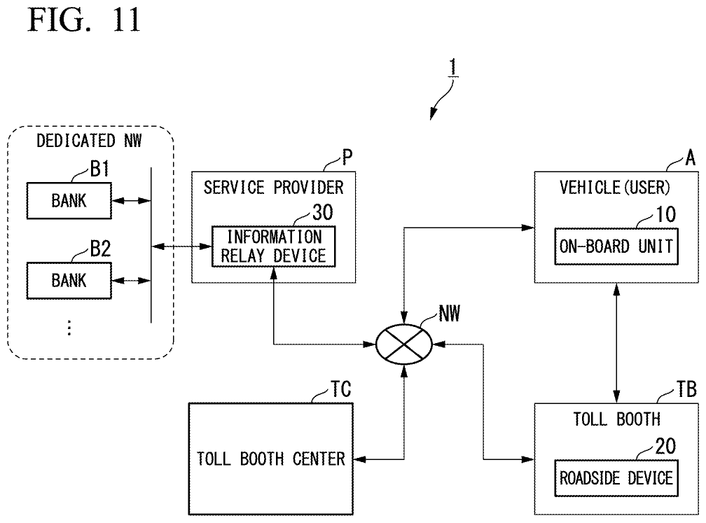

FIG. 11 is a diagram schematically showing a toll collection system according to a third embodiment of the present invention.

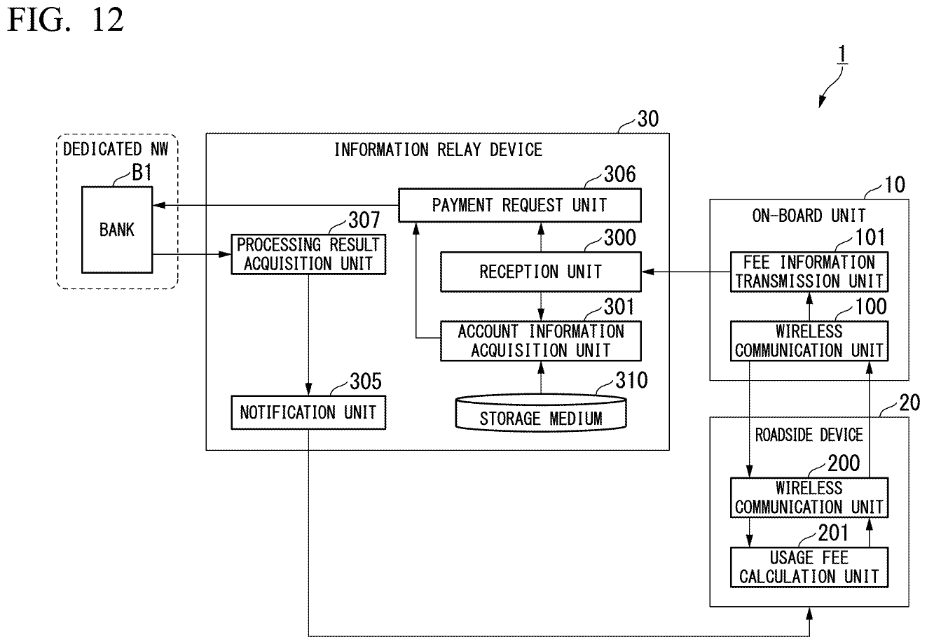

FIG. 12 is a diagram showing a functional configuration of the toll collection system according to the third embodiment of the present invention.

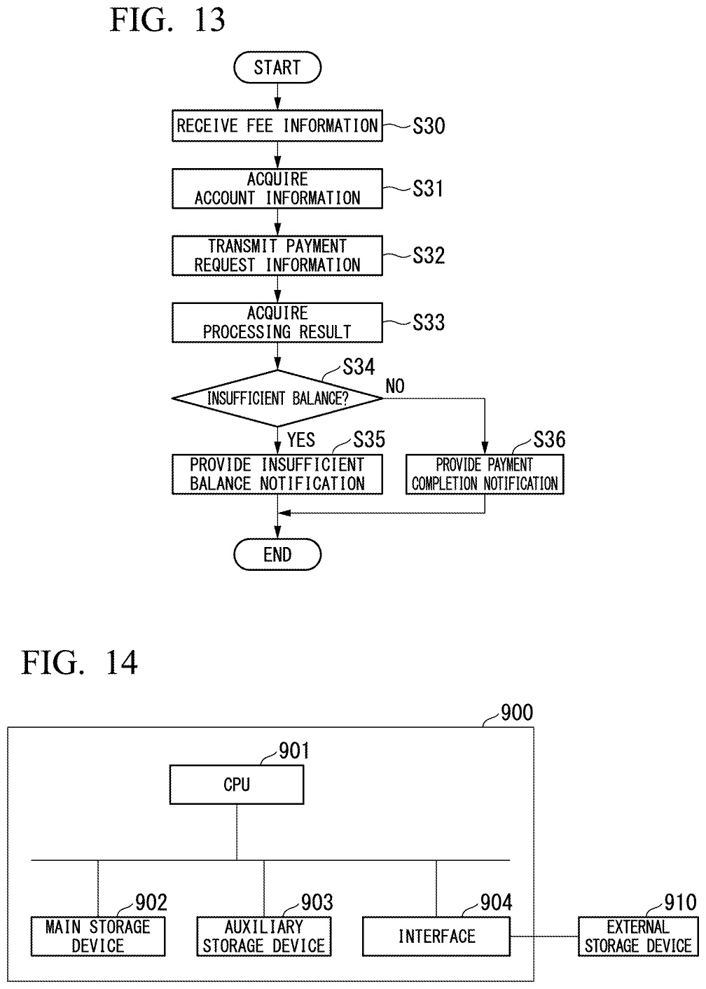

FIG. 13 is a flowchart showing an example of a process of an information relay device according to the third embodiment of the present invention.

Hereinafter, a toll collection system 1 according to the third embodiment of the present invention will be described with reference to FIGS. 11 to 13. Components common to the first embodiment are denoted by the same reference signs and a detailed description thereof will be omitted.

As shown in FIG. 11, the toll collection system 1 according to the present embodiment is different from the first and second embodiments in that a service provider P has an information relay device 30.

Also, functional components of an on-board unit 10 and a roadside device 20 are similar to those of the first or second embodiment. Although an aspect in which the on-board unit 10 transmits various types of information related to a toll collection process to the information relay device 30 is shown in the example of FIG. 12, as in the first embodiment, the present invention is not limited thereto. As in the second embodiment, an aspect in which the roadside device 20 transmits various types of information related to the toll collection process to the information relay device 30 may be used.

As shown in FIG. 12, the information relay device 30 according to the present embodiment includes a reception unit 300, an account information acquisition unit 301, a notification unit 305, a payment request unit 306, a processing result acquisition unit 307, and a storage medium 310.

Hereinafter, an example of a function and a process of the information relay device 30 according to the present embodiment will be described with reference to FIG. 13.

As shown in FIG. 13, first, the reception unit 300 receives the “fee information D1 (FIG. 3)” including “identification information” of the user and a “usage fee” for the user from the on-board unit 10 (or the roadside device 20) (step S30).

Next, the account information acquisition unit 301 retrieves and acquires “account information” associated with the “identification information” of the user from the registration table D2 (FIG. 4) pre-stored in the storage medium 310 (step S31).

Next, the payment request unit 306 identifies a payer (a bank B1) providing a payment means (a bank account in the bank B1) on the basis of the “account information” acquired by the account information acquisition unit 301 in step S31. The payment request unit 306 transmits the “payment request information D5 (FIG. 7)” to the payer (the bank B1) via a dedicated network (step S32).

When the payment request information D5 is received, the payer executes a process of paying (transmitting) the “usage fee” from the user's bank account identified from the “account information” to a bank account of a toll booth center TC identified from “payee information.”

Next, the processing result acquisition unit 307 acquires a processing result related to the payment of the usage fee by the payer (step S33).

The processing result acquisition unit 307 acquires a processing result indicating “payment completion” when the payment of the usage fee has been performed by the payer from the user's bank account normally. Also, the processing result acquisition unit 403 acquires a processing result indicating an “insufficient balance” when the payment of the usage fee has failed because the balance in the user's bank account is insufficient.

Next, the notification unit 305 determines whether or not the balance in the payment means (the bank account in the bank B1) of the user is insufficient (step S34).

When the processing result obtained by the processing result acquisition unit 307 in step S33 is the “insufficient balance” (step S34: YES), the notification unit 305 notifies the roadside device 20 that the balance in the user's payment means (bank account) is insufficient with respect to the usage fee (step S35). Then, the roadside device 20 provides a notification (an output) indicating that the balance is insufficient to the user via an output device (a display device, a speaker, or the like) (not shown).

On the other hand, when the processing result obtained by the processing result acquisition unit 307 in step S33 is “payment completion” (step S34: NO), the notification unit 305 notifies the roadside device 20 that payment of the usage fee from the payment means (the bank account) has been completed normally (step S36).

As described above, according to the present embodiment, the information relay device 30 provided in the service provider P for performing a payment process of paying a usage fee of a toll road includes the reception unit 300 configured to receive the fee information D1 including identification information for identifying a user of the toll road and the usage fee of the toll road for a user; the storage medium 310 storing the registration table D2 in which the identification information and account information for identifying a payment means of the user are pre-registered in association; and the payment request unit 306 configured to identify a payer for providing the payment means on the basis of the account information associated with the identification information and transmit the payment request information D5 including the account information and the usage fee to the payer.

Thereby, the information relay device 30 can appropriately transmit a payment request to each of the payers providing the payment means on the basis of the account information even if a different payment means is designated for each user. Thereby, the information relay device can provide the user with a payment service using various types of payment means as well as a credit card.

Also, because the account information of the user is stored only in the information relay device 30 provided in the service provider P, the information relay device 30 can sufficiently maintain the confidentiality of the account information for identifying the bank account.

Also, the information relay device 30 further includes the notification unit 305 configured to notify that a balance is insufficient when the balance in the payment means is less than the usage fee.

Thereby, the information relay device 30 can immediately notify the user that the balance in the payment means is insufficient.

FIG. 14 is a schematic block diagram showing a configuration of a computer according to at least one embodiment.

A computer 900 includes a CPU 901, a main storage device 902, an auxiliary storage device 903, and an interface 904.

The information relay device 30 and the processing device 40 according to each of the above-described embodiments are installed in the computer 900. The operation of each processing unit described above is stored in the auxiliary storage device 903 in the form of a program. The CPU 901 reads the program from the auxiliary storage device 903, loads the program into the main storage device 902, and executes the above process according to the program. Also, the CPU 901 secures a storage area corresponding to the above-described storage medium 310 in the main storage device 902 in accordance with the program.

Examples of the auxiliary storage device 903 include a hard disk drive (HDD), a solid-state drive (SSD), a magnetic disk, a magneto-optical disc, a compact disc read only memory (CD-ROM), and a digital versatile disc read only memory (DVD-ROM), a semiconductor memory, and the like. The auxiliary storage device 903 may be an internal medium directly connected to the bus of the computer 900 or may be an external medium connected to the computer 900 via the interface 904 or a communication circuit. Also, when the program is distributed to the computer 900 via the communication circuit, the computer 900 receiving the distributed program may load the program into the main storage device 902 and execute the above process. In at least one embodiment, the auxiliary storage device 903 is a non-transitory tangible storage medium.

Also, the above-described program may be a program for implementing some of the above-described functions. Further, the above-described program may be a program capable of implementing the above-described function in combination with another program already stored in the auxiliary storage device 903, i.e., a so-called differential file (differential program).

Although the embodiments of the present invention have been described in detail above, the present invention is not limited thereto and some design changes are possible without departing from the technical idea of the present invention.

For example, although an aspect in which the identification information and the account information are associated one-to-one in the registration table D2 has been described in the above-described embodiment, the present invention is not limited thereto. In another embodiment, when the user has a plurality of different payment means, a plurality of pieces of account information may be associated with one piece of identification information in the registration table D2. Specifically, it is assumed that the user has bank accounts in a plurality of countries (a country A and a country B). In this case, in the registration table D2, account information indicating a bank account of the country A and account information indicating a bank account of the country B are associated with identification information of the user. In this case, the account information acquisition unit 301 of the information relay device 30 may acquire account information corresponding to the currency of the usage fee included in the fee information D1 from the registration table D2. That is, when the usage fee of the fee information D1 is input in the currency of the country A (for example, yen), the account information acquisition unit 301 acquires account information indicating the bank account of the country A.

Also, in still another embodiment, the account information acquisition unit 301 may acquire a plurality of pieces of account information registered in the registration table D2 and transmit the acquired information to the processing device 40. In this case, the payment request unit 402 of the processing device 40 may make a payment request while selecting account information corresponding to the currency of the usage fee included in the bill information D3 from among the plurality of pieces of account information.

Thereby, the information relay device 30 and the processing device 40 can automatically select an appropriate payment means according to the usage fee from the plurality of pieces of account information associated with the identification information of the user and perform the payment process.

Also, although an aspect in which the on-board unit 10 and the roadside device 20 perform wireless communication at the toll booth TB to perform the toll collection process has been described in the above-described embodiment, the present invention is not limited thereto.

In another embodiment, the on-board unit 10 may be configured to measure a traveling position of the vehicle A using, for example, the technology of a global navigation satellite system (GNSS) and calculate a usage fee of a toll road on which the vehicle A has traveled with reference to road map data pre-stored in the on-board unit 10. In this case, the roadside device 20 may be omitted from the toll collection system 1.

### INDUSTRIAL APPLICABILITY

According to the information relay device, the information relay method, and the program described above, it is possible to provide a payment service in which a plurality of types of payment means are available.

### REFERENCE SIGNS LIST

1 Toll collection system

10 On-board unit

100 Wireless communication unit

101 Fee information transmission unit

20 Roadside device

200 Wireless communication unit

201 Usage fee calculation unit

202 Fee information transmission unit

30 Information relay device

300 Reception unit

301 Account information acquisition unit

302 Security communication API (security communication unit)

303 Transmission unit

304 Payment information reception unit

305 Notification unit

306 Payment request unit

307 Processing result acquisition unit

310 Storage medium

40 Processing device

400 Reception unit

401 Security communication API (security communication unit)

402 Payment request unit

403 Processing result acquisition unit

404 Payment information notification unit

1. An information relay device for relaying information related to a payment process from and to a service provider for performing the payment process of paying a usage fee of a toll road, the information relay device comprising:
a reception unit configured to receive information including identification information for identifying a user of the toll road and the usage fee of the toll road for the user;
a storage medium storing a registration table in which the identification information and account information for identifying a payment means of the user are pre-registered in association;
a security communication unit provided from the service provider and configured to generate encrypted information in which the account information associated with the identification information and the usage fee are encrypted; and
a transmission unit configured to transmit the encrypted information to the service provider.

2. The information relay device according to claim 1, further comprising a notification unit configured to notify that a balance is insufficient when the balance in the payment means is less than the usage fee.

3. An information relay device provided in a service provider for performing a payment process of paying a usage fee of a toll road, the information relay device comprising:
a reception unit configured to receive information including identification information for identifying a user of the toll road and the usage fee of the toll road for the user;
a storage medium storing a registration table in which the identification information and account information for identifying a payment means of the user are pre-registered in association; and
a payment request unit configured to identify a payer for providing the payment means on the basis of the account information associated with the identification information and transmit payment request information including the account information and the usage fee to the payer.

4. The information relay device according to claim 3, further comprising a notification unit configured to notify that a balance is insufficient when the balance in the payment means is less than the usage fee.

5. An information relay method of relaying information related to a payment process from and to a service provider for performing the payment process of paying a usage fee of a toll road, the information relay method comprising the steps of:
receiving information including identification information for identifying a user of the toll road and the usage fee of the toll road for the user;
generating encrypted information in which account information associated with the identification information and the usage fee are encrypted by a security communication unit provided from the service provider; and transmitting the encrypted information to the service provider.

6. (canceled)

7. (canceled)

8. (canceled)
